(19) United States
(12) Patent Application Publication
(10) Pub. No.: US 2025/0348058 A1
(43) Pub. Date: Nov. 13, 2025

(54) INFORMATION PROCESSING METHOD AND INFORMATION PROCESSING DEVICE

(71) Applicant: Panasonic Intellectual Property Management Co., Ltd., Osaka (JP)

(72) Inventors: NOBUO HARA, Osaka (JP); MIKIO USHIODA, Kanagawa (JP); MASAHIRO TAKEZAWA, Osaka (JP); AKIHISA NAKAHASHI, Osaka (JP)

(21) Appl. No.: 19/278,855

(22) Filed: Jul. 24, 2025

Related U.S. Application Data
(63) Continuation of application No. PCT/JP2023/043003, filed on Nov. 30, 2023.

(30) Foreign Application Priority Data
Feb. 6, 2023 (JP) 2023-016321

(51) Int. Cl. G05B 19/418

(52) U.S. Cl. CPC G05B 19/4184; G05B 19/41885

(57) ABSTRACT

An information processing method includes: acquiring a first data set including condition data and result data on first machining performed by a first device (S101); generating an integrated data set including the first data set (S102); acquiring a second data set including condition data and result data on second machining performed by a second device; adding the second data set or a correction data set to the integrated data set (S108); and generating the correction data set by selecting one data set from the second data set or the modified data set, already added to the integrated data set, and correcting the condition data included in the second data set to the correction data, when the correction data is generated. The correction data satisfies a condition that a difference between result data indicating a result of a machining simulation performed under the condition of the correction data and result data included in the one data set is smaller than a predetermined value.

### TECHNICAL FIELD

The present disclosure relates to an information processing method and an information processing device.

### BACKGROUND ART

Data acquired from a plurality of devices different from each other has been conventionally and collectively managed and processed.

For example, PTL 1 discloses a monitoring device that is connected to a plurality of machine tools through a network to collect data from the plurality of machine tools, and that monitors the plurality of machine tools using the collected data.

### CITATION LIST

### Patent Literature

PTL 1: Unexamined Japanese Patent Publication No. 2018-128715

### SUMMARY OF THE INVENTION

An information processing method according to an aspect of the present disclosure includes: acquiring one or more first data sets for one or more pieces of first machining performed by a first device, each of the one or more first data sets including condition data indicating a condition of a corresponding one of the one or more pieces of first machining and result data indicating a result of the corresponding one of the one or more pieces of first machining; generating an integrated data set including the acquired one or more first data sets; acquiring a plurality of second data sets for a plurality of pieces of second machining performed by a plurality of second devices, each of the plurality of second data sets including condition data indicating a condition of a corresponding one of the plurality of pieces of second machining and result data indicating a result of the corresponding one of the plurality of pieces of second machining; adding, for each of the plurality of second devices, (i) a corresponding one of the plurality of second data sets or (ii) a correction data set generated using the corresponding one of the plurality of second data sets to the integrated data set; selecting one data set which is already added to the integrated data set, the one data set being a second data set or a correction data set, a difference existing between the condition data included in the one data set and the condition data included in the corresponding one of plurality of second data sets, the difference being smaller than a predetermined value; and correcting the condition data included in the corresponding one of the plurality of second data sets to correction data to generate the correction data set, the correction data satisfying a condition that a difference between result data indicating a result of a machining simulation performed under the condition of the correction data and result data included in the one data set is smaller than a predetermined value.

These comprehensive or specific aspects may be achieved by a system, a device, an integrated circuit, a computer program, or a recording medium such as a computer-readable CD-ROM, and may be achieved by any combination of the system, the device, the integrated circuit, the computer program, and the recording medium.

### BRIEF DESCRIPTION OF THE DRAWINGS

FIG. 1 is an explanatory diagram illustrating a functional configuration of a system and a processing device according to an exemplary embodiment.

FIG. 2A is an explanatory diagram illustrating parameters related to laser welding.

FIG. 2B is an explanatory diagram illustrating data normalization and standardization.

FIG. 3 is a first flowchart illustrating processing performed by a processing device according to an exemplary embodiment.

FIG. 4 is a second flowchart illustrating processing performed by a processing device according to an exemplary embodiment.

FIG. 5 is an explanatory diagram of an example of a data set for machining performed by a reference device according to an exemplary embodiment.

FIG. 6 is an explanatory diagram of an example of a first data set for machining simulation according to an exemplary embodiment.

FIG. 7 is an explanatory diagram of an example of a data set for machining performed by a machining device according to an exemplary embodiment.

FIG. 8 is an explanatory diagram of an example of a second data set for a machining simulation according to an exemplary embodiment.

FIG. 9 is an explanatory diagram of an example of a correction data set for machining performed by a machining device according to an exemplary embodiment.

FIG. 10 is an explanatory diagram of an example of an integrated data set according to an exemplary embodiment.

### DESCRIPTION OF EMBODIMENT

When data acquired by a plurality of devices is collectively managed, the data may be handled on the assumption that data values that are not to be managed are equal in the plurality of devices.

However, data values that are not to be managed may be actually different among a plurality of devices. When the data, in which values are different from each other, is handled on the assumption that the data values that are not to be managed are equal among the plurality of devices, a result may be inappropriate. The data is used to generate a model for estimating a result from a machining condition, for example. When data values not to be managed are different among a plurality of devices, accuracy of estimation of a model to be generated deteriorates.

Thus, the present disclosure provides an information processing method and the like for appropriately integrating data acquired from a plurality of devices.

An information processing method according to an aspect of the present disclosure includes acquiring one or more first data sets and generating an integrated data set including the acquired one or more first data sets. Each of the one or more first data sets includes data for each of one or more pieces of first machining performed by a first device, the data including condition data indicating a condition of the first machining and result data indicating a result of the first machining. The information processing method further includes acquiring a plurality of second data sets related to second processing performed by each of a plurality of second devices, and adding a second data set related to machining performed by the second device or a correction data set generated using the second data set to the integrated data set for each of the plurality of second devices. Each of the plurality of second data sets includes condition data indicating a condition of the second machining and result data indicating a result of the second machining. The generating of the modified data set includes: selecting one data set of the second data set and the correction data set already added to the integrated data set; and correcting the condition data included in the second data set to correction data to generate the correction data set. The one data set includes a difference between the condition data included in the one data set and the condition data included in the second data set, the difference being smaller than a predetermined value. The correction data satisfies a condition that a difference between result data indicating a result of a machining simulation performed under the condition of the correction data and result data included in the one data set is smaller than a predetermined value.

According to the above aspect, the data set for the machining performed by the second device and including a relatively small difference from the data set already added to the integrated data set is added to the integrated data set. At this time, when the difference between the data set for the machining performed by the second device and the data set already added to the integrated data set is relatively large, the data set for the machining performed by the second device is corrected using a machining simulation simulating the machining performed by the first device to reduce the difference, and then is added to the integrated data set. Consequently, the data set for the machining performed by the first device and the data set for the machining performed by the second device can be appropriately integrated. As described above, the information processing method enables the data acquired from the plurality of devices to be appropriately integrated.

For example, the adding of the second data set or the correction data set may include: determining whether a difference between a first model and a second model is larger than a predetermined value, the first model being for estimating the result data included in the one data set using the condition data included in the one data set and the second model being for estimating the result data included in the second data set using the condition data included in the second data set; and generating the correction data set and adding the correction data set to the integrated data set when it is determined that the difference is larger than the predetermined value.

According to the above aspect, it can be easily determined whether to correct the data set for the machining performed by the second device by using a difference between models for estimating the result data from the condition data for each of the data set already added for the second device and the data set for the machining performed by the second device. More specifically, when the difference is relatively large, it can be determined that the data set for the machining performed by the second device is to be corrected. Thus, the information processing method enables the data acquired from the plurality of devices to be appropriately integrated more easily.

For example, the adding of the second data set or the correction data set may include: determining whether a difference between a first model and a second model is larger than a predetermined value, the first model being for estimating the result data included in the one data set using the condition data included in the one data set and the second model being for estimating the result data included in the second data set using the condition data included in the second data set; and adding the second data set to the integrated data set when it is determined that the difference is not larger than the predetermined value.

According to the above aspect, it can be easily determined whether to correct the data set for the machining performed by the second device by using a difference between models for estimating the result data from the condition data for each of the data set already added for the second device and the data set for the machining performed by the second device. More specifically, when the difference is relatively small, it is determined not to correct the data set for the machining performed by the second device, i.e., the data set for the machining performed by the second device is directly added to the data set for the machining performed by the first device. Thus, the information processing method enables the data acquired from the plurality of devices to be appropriately integrated more easily.

For example, the information processing method may further include creating a machining simulator simulating the first machining using condition data indicating a condition of the first machining and result data indicating a result of the first machining, and performing the machining simulation using the created machining simulator.

According to the above aspect, the machining simulator simulating the machining performed by the first device is generated and used, so that a difference between the data set for the machining performed by the second device and the data set already added to the integrated data set can be evaluated with higher accuracy. As described above, the information processing method enables the data acquired from the plurality of devices to be appropriately integrated.

For example, correcting the condition data included in the second data set may include changing a data value of data defined as data not to be controlled or measured among the condition data included in the second data set.

According to the above aspect, the data value of the data defined as the data not to be controlled or measured is changed when the data set for the machining performed by the second device is corrected, so that the data set for the machining performed by the second device is added to the data set for the machining performed by the first device after the data value of the data not to be controlled or measured included in the data set for the machining performed by the second device is appropriately set. Thus, the information processing method enables the data acquired from the plurality of devices to be appropriately integrated even when the data set for the machining performed by the second device includes data not to be controlled or measured.

For example, the information processing method may further include generating a third model for estimating the result data included in the integrated data set using the condition data included in the integrated data set after the second data sets or the correction data sets of the plurality of second devices are added.

According to the above aspect, the model for estimating the result data from the condition data can be appropriately generated using the integrated data set in which the data set for the machining performed by the first device and the data set for the machining performed by the second device are appropriately integrated. Thus, the information processing method enables the data acquired from the plurality of devices to be appropriately integrated, and an appropriate model to be generated using the integrated data set.

An information processing device according to an aspect of the present disclosure includes an acquisition unit and a processor connected to the acquisition unit. The acquisition unit acquires one or more first data sets. Each of the one or more first data sets includes a first data set for each of one or more pieces of first machining performed by a first device, the first data set including condition data indicating a condition of the first machining and result data indicating a result of the first machining. The processor generates an integrated data set including the one or more first data sets acquired by the acquisition unit. The acquisition unit acquires a plurality of second data sets related to second machining performed by each of a plurality of second devices. Each of the plurality of second data sets includes condition data indicating a condition of the second machining and result data indicating a result of the second machining. The processor adds a second data set for machining performed by the second device or a correction data set generated using the second data set to the integrated data set for each of the plurality of second devices. The processor generates the correction data set by selecting one data set of the second data set or the correction data set already added to the integrated data set and by correcting the condition data included in the second data set to correction data to generate the correction data set. The one data set includes a difference between the condition data included in the one data set and the condition data included in the second data set, the difference being smaller than a predetermined value. The correction data satisfies a condition that a difference between result data indicating a result of a machining simulation performed under the condition of the correction data and result data included in the one data set is smaller than a predetermined value.

According to the above aspect, effect similar to that of the information processing method is achieved.

These comprehensive or specific aspects may be achieved by a system, a device, an integrated circuit, a computer program, or a recording medium such as a computer-readable CD-ROM, and may be achieved by any combination of the system, the device, the integrated circuit, the computer program, or the recording medium.

Hereinafter, exemplary embodiments will be specifically described with reference to the drawings.

The exemplary embodiments described below illustrate comprehensive or specific examples. Numerical values, shapes, materials, constituent elements, arrangement positions and connection configurations of the constituent elements, steps, processing order of the steps, and the like shown in the following exemplary embodiment are just an example, and are not intended to limit the present disclosure. Those components introduced in the following exemplary embodiments that are not described in the independent claims representing the most superordinate concept are illustrated herein as optional components.

### EXEMPLARY EMBODIMENT

In the present exemplary embodiment, an information processing method and the like for appropriately integrating data acquired from a plurality of devices will be described.

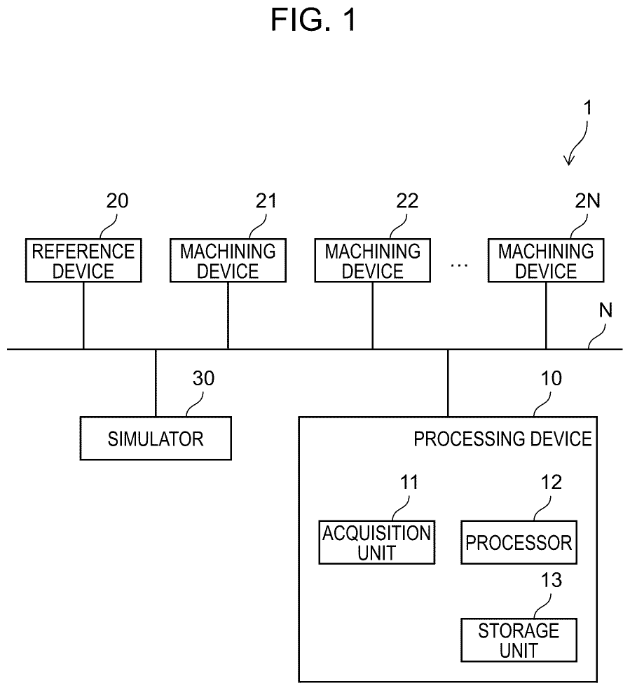

FIG. 1 is an explanatory diagram illustrating configurations of system 1 and processing device 10 according to the present embodiment.

As illustrated in FIG. 1, system 1 includes processing device 10, reference device 20, machining devices 21, 22, . . . , 2N (referred to also as machining device 21 or the like), and simulator 30. The devices included in system 1 are communicably connected through network N.

Reference device 20 performs machining. Examples of the machining include laser welding. When performing the machining, reference device 20 generates a data set including condition data indicating conditions of the machining and a data set including result data indicating a result of the machining, and stores the generated data set.

Here, the condition data indicates conditions of machining, and includes one or more data values. Specifically, the condition data may include data such as dimension, speed, time, or substance related to the machining, or a purpose or a location related to the machining, or information on a user. The result data indicates a result of the machining and includes one or more data values. Specifically, the result data may include data such as dimension, speed, time, or substance related to the result of the machining.

Reference device 20 is used by a relatively large number of users for machining for various purposes, for example. The data set generated by reference device 20 includes condition data on machining for various purposes set by a relatively large number of users and result data on the machining performed under conditions in the condition data, for example. Thus, the condition data included in the data set generated by reference device 20 is scattered in the entire set of condition data that can be set, i.e., has a feature of being sparse. Reference device 20 is owned by a research institution such as a university, and is used by various companies or research institutions, for example.

The condition data includes data to be managed in a manufacturing line and data not to be managed. The result data includes data to be managed in the manufacturing line and data not to be managed.

Data to be managed is controlled or measured in a manufacturing line. Data that is relatively easily controlled or measured in a control line is treated as data to be managed. In contrast, data not to be managed is not controlled and measured in the manufacturing line. Data that is difficult or impossible to be controlled or measured in the control line is treated as data that is not to be managed.

Reference device 20 stores the generated data set in a distinctive manner in association with attribute information (e.g., a purpose of the machining, a material of a target of the machining, or the like) related to the machining. For example, when the machining is laser welding, reference device 20 stores a data set indicating overlay welding and a data set indicating butt welding in a distinctive manner. This is because condition data or result data to be evaluated is different between the overlay welding and the butt welding. When different materials are to be machined, reference device 20 generally stores the materials as separate data sets distinguished from each other. However, the materials can be treated as identical data set without distinction as long as machining can be modeled into one model using physical properties such as specific heat or melting point.

Machining device 21 performs the same kind of machining as reference device 20. As with reference device 20, when performing the machining, machining device 21 generates a data set including condition data indicating conditions of the machining and a data set including result data indicating a result of the machining, and stores the generated data set. Machining device 21 may have the same hardware configuration as reference device 20 or may have a different hardware configuration.

Machining device 21 is used for machining for similar purposes by a relatively small number of users, for example. The data set generated by machining device 21 includes condition data on machining for similar purposes set by a relatively small number of users and result data on the machining performed under conditions in the condition data, for example. Thus, the condition data included in the data set generated by machining device 21 is localized in the entire set of condition data that can be set, i.e., has a feature of being locally dense. Machining device 21 is owned by one company and used for manufacturing or research of a product of the company, for example.

As with machining device 21, each of machining devices 22 to 2N performs the same kind of machining as reference device 20, and is provided and used independently of machining device 21. Detailed description of machining devices 22 to 2N is similar to that of machining device 21, and thus is not described.

Each of machining devices 21 to 2N generates a data set including condition data that is localized at positions in the entire set of condition data that can be set, the positions being independent, i.e., the positions may be matched or different.

Although an example will be described in which the number of machining devices 21 to 2N is N, the number of machining devices 22 to 2N may be any number as long as it is two or more.

Here, data to be managed and data not to be managed will be described for laser welding as an example of machining.

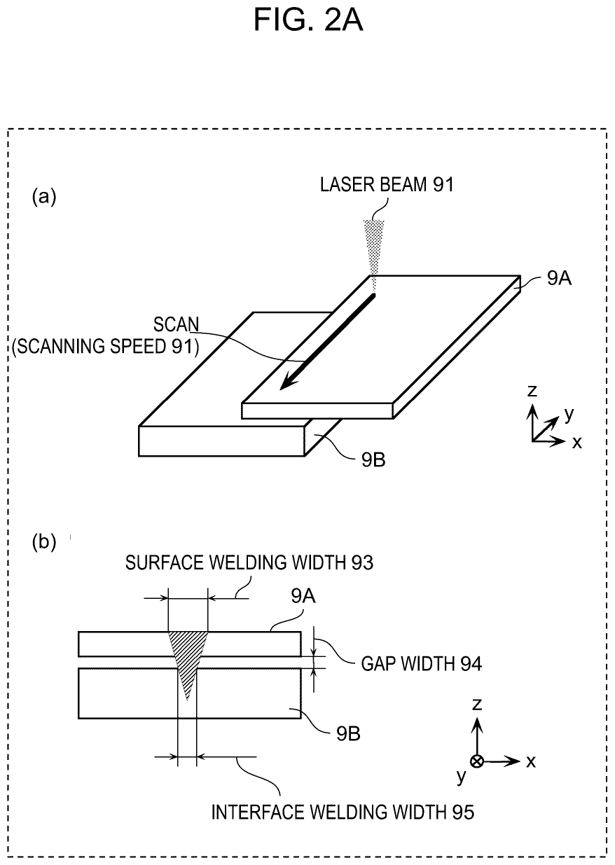

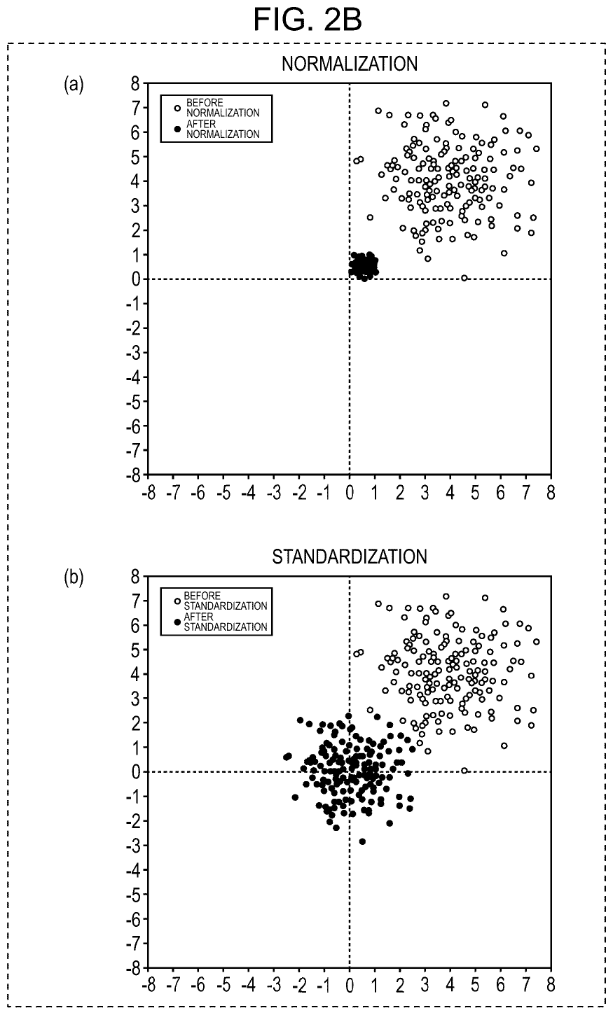

FIG. 2A is an explanatory diagram illustrating parameters related to laser welding in a manufacturing line, as an example of machining.

Part (a) of FIG. 2A schematically illustrates a state of a laser welding process in which reference device 20 welds plates 9A and 9B by laser welding. As illustrated in part (a) of FIG. 2A, plates 9A and 9B are disposed overlapping each other partially. Reference device 20 irradiates a region where plates 9A and 9B overlap with each other while scanning the region with laser beam 91.

Part (b) of FIG. 2A schematically illustrates a state of a section of plates 9A and 9B welded by laser welding performed by reference device 20. As illustrated in part (b) of FIG. 2A, plates 9A and 9B includes a part that is irradiated with laser beam 91 and is welded. Plates 9A and 9B include a weld having a width on an upper surface (i.e., a surface viewed from a positive direction in a Z axis) of plate 9A, the width being referred to as surface welding width 93, and a width in an interface between plates 9A and 9B, the width being referred to as interface welding width 95. Between plates 9A and 9B, a minute gap having gap width 94 exists.

The condition data includes data to be managed, the data including scanning speed 91 of laser.

The condition data includes data not to be managed, the data including gap width 94 between plates 9A and 9B to be welded, for example. Gap width 94 can be controlled by using a jig in an off-line experiment, and can be controlled by setting a simulation condition in a simulation experiment.

The result data includes data to be managed, the data including surface welding width 93 of a laser weld, for example.

The result data includes data not to be managed, the data including interface welding width 95 in the interface between plates 9A and 9B of the laser weld, for example. Although there is a method for cutting a machined product after machining and performing measurement on a cut surface to directly measure interface welding width 95, for example, such measurement is difficult or impossible in-line.

Returning to FIG. 1, simulator 30 is a machining simulator that performs a machining simulation (referred to also simply as a simulation) simulating machining of reference device 20. Simulator 30 calculates the result data by performing numerical calculation simulating a physical phenomenon corresponding to machining of reference device 20 using the condition data. Simulator 30 is capable of calculating the result data using the condition data set relatively freely by the user.

Processing device 10 is an information processing device that generates a data set (referred to also as an integrated data set) obtained by integrating a data set of reference device 20 and a data set of machining device 21 or the like.

As illustrated in FIG. 1, processing device 10 includes acquisition unit 11, processor 12, and storage unit 13 as functional units. Processing device 10 includes the functional units that are implemented by a processor (e.g., a central processing unit (CPU)) included in the processing device 10 and caused to execute a predetermined program using a memory, for example.

Acquisition unit 11 is a functional unit that acquires a data set. When acquiring a data set, acquisition unit 11 acquires the data set from a device including the data set by communication through network N. The data set includes data on machining, the data including condition data indicating conditions of the machining and result data indicating a result of the machining.

Specifically, acquisition unit 11 acquires one or more data sets (corresponding to the first data set) for machining performed by reference device 20 from reference device 20.

Acquisition unit 11 also acquires a data set (corresponding to the second data set) for machining performed by machining device 21 from machining device 21. Similarly, acquisition unit 11 acquires a data set (corresponding to the second data set) for machining performed by machining devices 22 to 2N from each of the machining devices.

Processor 12 is a functional unit that executes processing of generating an integrated data set. Processor 12 generates the integrated data set by processing the data set (i.e., the first data set and the second data set) acquired by acquisition unit 11. The processing executed by processor 12 will be specifically described.

Processor 12 generates an integrated data set including one or more first data sets acquired by acquisition unit 11. Next, processor 12 adds a second data set or a correction data set generated using the second data set to the integrated data set for each of the plurality of machining devices 21 and the like, the second data set being for machining performed by the corresponding one of the machining devices.

When generating the correction data set, processor 12 selects one data set of the second data set and the correction data set already added to the integrated data set, the one data set including a difference between the condition data included in the one data set and the condition data included in the second data set, the difference being smaller than a predetermined value. Then, processor 12 generates a correction data set by correcting the condition data included in the second data set to correction data. Here, the correction data satisfies a condition that a difference between result data indicating a result of a simulation performed under conditions in the correction data and result data included in the one data set is smaller than a predetermined value. Here, examples of the difference between the condition data include a Euclidean distance after each data value is normalized or standardized. The condition, “the difference between the condition data is smaller than the predetermined value”, can be set to a condition that the Euclidean distance after normalizing the two condition data is 0.1 or less, or that the Euclidean distance after normalizing the two condition data is 0.05 or less, for example. Which one of normalization and standardization is used can be determined by a type of data.

Normalization and standardization of data is as illustrated in FIG. 2B. That is, the normalization is to divide deviation from a minimum value of all data by a data range for each data. The normalization causes a minimum value of data to be converted into 0, and a maximum value of the data to be converted into 1 (see part (a) of FIG. 2B). The standardization is to divide a deviation from an average value of all data by a standard deviation for each data. The standardization causes an average value of the data to be converted into 0, and a variance of the data to be converted into 1 (see part (b) of FIG. 2B).

When adding the second data set or the correction data set, processor 12 determines whether a difference between a first model and a second model is larger than a predetermined value, the first model being for estimating result data included in the one data set using the condition data included in the one data set, and the second model being for estimating result data included in the second data set using the condition data included in the second data set. Then, when determining that the difference is larger than the predetermined value, processor 12 generates a correction data set and adds the correction data set to the integrated data set. When determining that the difference is not larger than the predetermined value, processor 12 adds the second data set to the integrated data set.

When correcting the condition data included in the second data set, processor 12 can change a data value of data defined as data not to be managed, the data being included in the condition data included in the second data set.

Storage unit 13 is a functional unit that stores an integrated data set, and is implemented by a storage device. Storage unit 13 stores the integrated data set generated by processor 12. The integrated data set stored in storage unit 13 may be output to a device outside processing device 10 or may be used for a function of processing device 10. For example, the integrated data set stored in storage unit 13 is used to generate a model (corresponding to the third model) for estimating result data included in the integrated data set using the condition data included in the integrated data set. The third model may be generated by a device outside processing device 10 or by a function of processing device 10.

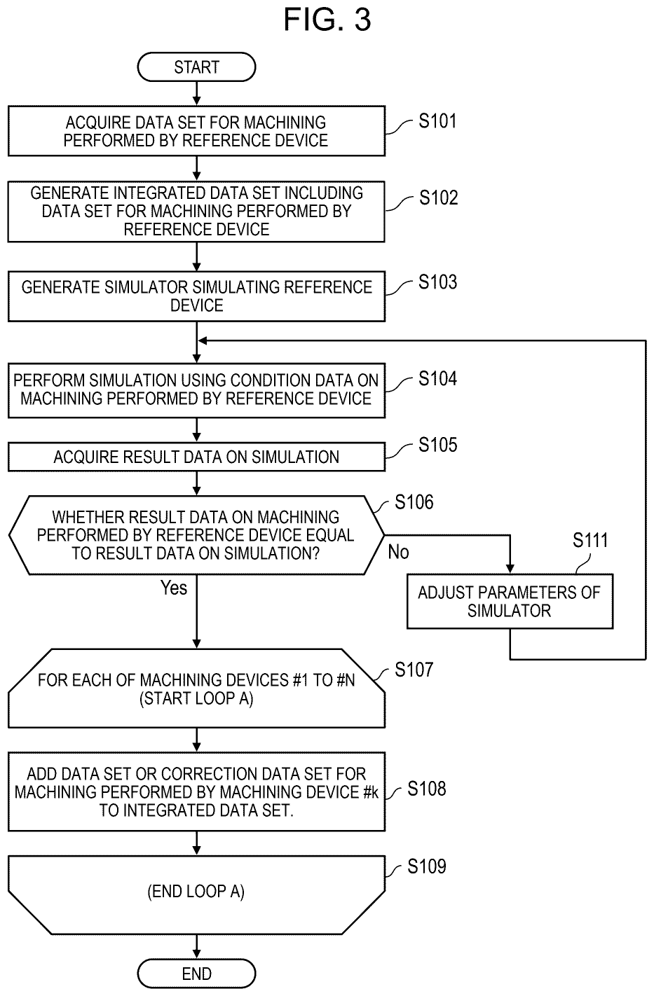

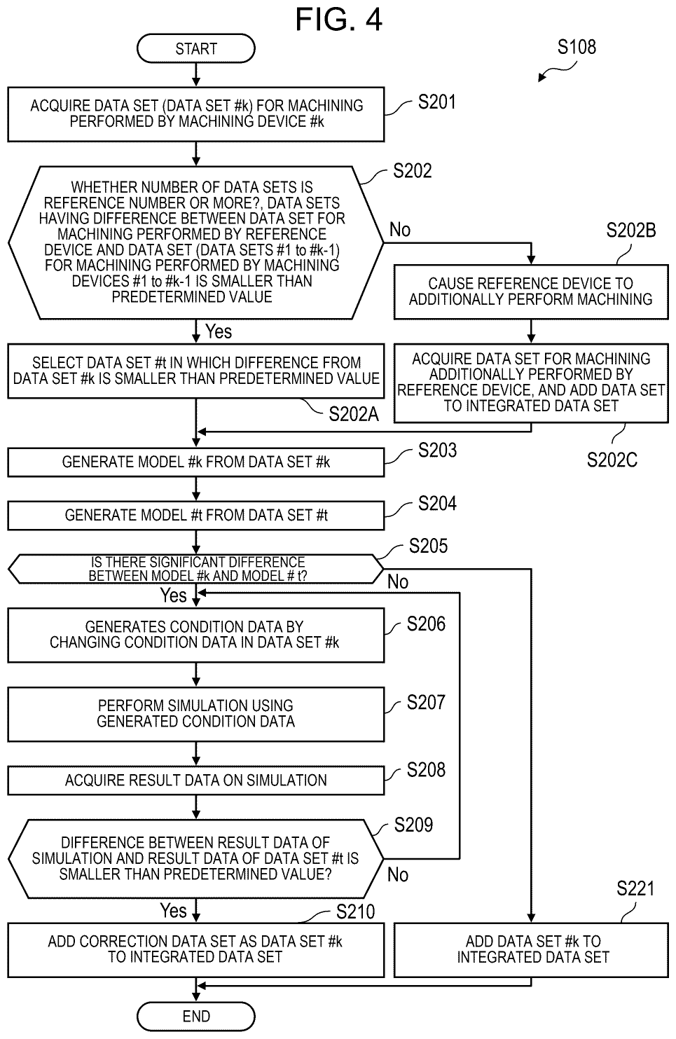

FIGS. 3 and 4 are each a flowchart illustrating processing performed by processing device 10 according to the present exemplary embodiment. With reference to these drawings, the processing performed by processing device 10 will be described.

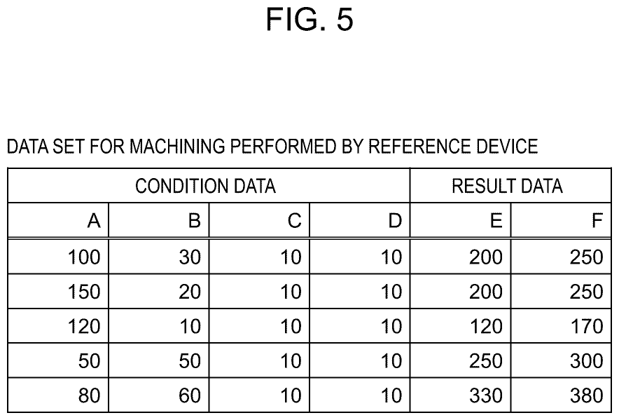

In step S101 illustrated in FIG. 3, acquisition unit 11 acquires a data set for machining performed by reference device 20. FIG. 5 (described below) shows an example of the data set for the machining performed by reference device 20.

In step S102, processor 12 generates an integrated data set including the data set for the machining performed by reference device 20 acquired by acquisition unit 11 in step S101. At this point, the integrated data set includes the data set for the machining performed by reference device 20.

In step S103, processor 12 generates simulator 30 simulating reference device 20. Simulator 30 is generated by adjusting operation parameters (e.g., a parameter related to physical properties or a parameter related to boundary conditions) in an existing simulator in which the operation parameters are adjustable. Processor 12 generates simulator 30 by adjusting the operation parameters of the simulator to obtain result data included in the data set acquired in step S101 as a result of the simulation performed using condition data included in the data set acquired in step S101. The operation parameters can be adjusted by a method such as Bayesian optimization, for example.

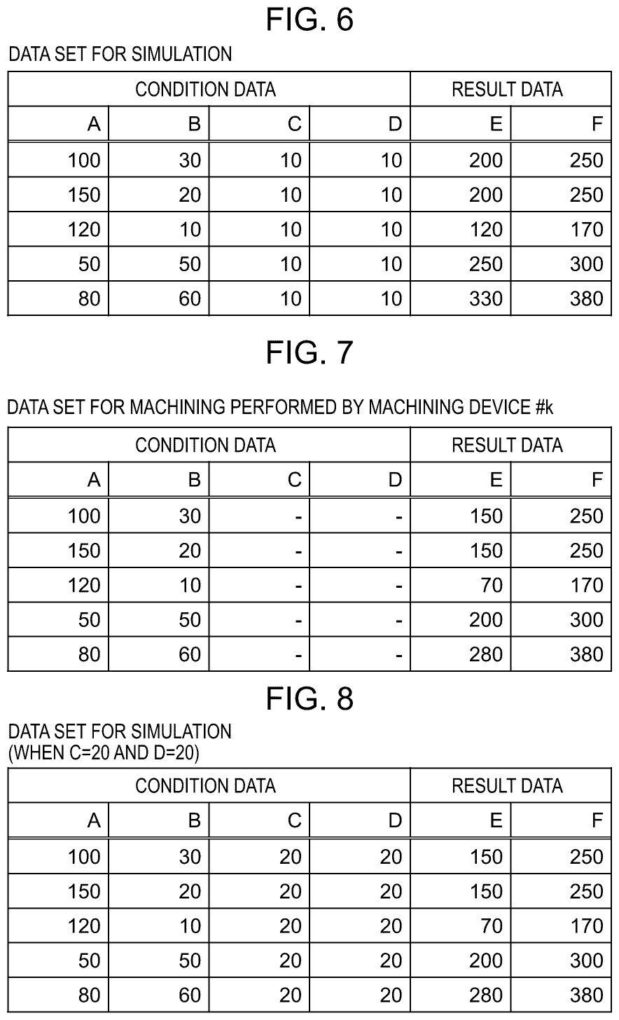

In step S104, processor 12 causes simulator 30 to perform simulation using the condition data on the machining performed by reference device 20. When causing simulator 30 to perform the simulation, processor 12 provides simulator 30 with the condition data on the machining performed by reference device 20, and transmits control information for performing the simulation using the provided condition data to simulator 30. FIG. 6 (described below) shows an example of a data set for the simulation.

In step S105, processor 12 acquires result data on the simulation performed by simulator 30 in step S104. For example, processor 12 can acquire the result data by transmitting request information for acquiring the result data to simulator 30 and receiving the result data transmitted in response to the request information.

In step S106, processor 12 uses the result data on the simulation acquired in step S105 to determine whether a difference between the result data on the machining performed by reference device 20 and the result data on the simulation is smaller than a predetermined value. When it is determined that the difference is smaller than the predetermined value (Yes in step S106), the processing proceeds to step S107, and otherwise (No in step S106), the processing proceeds to step S111.

In step S107, processing device 10 performs start processing of loop A for repeatedly performing the processing in step S108 described later. Loop A causes the processing to be performed focusing on each of machining devices 21 to 2N to finally result in performing the processing on all of machining devices 21 to 2N. Here, machining devices 21 to 2N are referred to also as machining devices #1 to #N, and a machining device of interest is referred to also as machining device #k. Here, k is an integer value sequentially assigned to each device of machining devices 21 to 2N from 1, and increases with the number of repetitions in loop A.

In step S108, processor 12 adds a data set or a correction data set for machining performed by machining device #k to the integrated data set.

In step S109, processing device 10 performs termination processing of loop A. Specifically, processing device 10 determines whether the processing of step S108 has been performed focusing on each of machining devices 21 to 2N. When the processing has not been performed on all of them, processing device 10 controls performing the processing focusing on a machining device on which the processing has not yet been performed.

In step S111, processor 12 adjusts the operation parameters of simulator 30 created in step S103. For example, when simulation is performed using simulator 30 after the operation parameters are adjusted in step S111, processor 12 adjusts the operation parameters to reduce a difference between the result data on the machining performed by reference device 20 and result data on the simulation to smaller than a predetermined value. The operation parameters can be adjusted by a method such as Bayesian optimization, for example.

Details of the processing included in step S108 of FIG. 3 will be described with reference to FIG. 4.

In step S201 illustrated in FIG. 4, processor 12 acquires a data set for machining performed by machining device #k.

In step S202, processor 12 determines whether there are a reference number or more of data sets having a difference from data set #k, the difference being smaller than a predetermined value between the data set for the machining performed by reference device 20 and the data sets (data sets #1 to #k−1) for machining performed by machining devices #1 to #k−1. When processor 12 determines that the number of data sets having a difference from data set #k, the difference being smaller than the predetermined value, is equal to or larger than the reference number (Yes in step S202), the processing proceeds to step S202A, and otherwise (No in step S202), the processing proceeds to step S202B.

In step S202, data sets #1 to #k−1 are each one data set of the second data set or the correction data set already added to the integrated data set. The data set for the machining performed by the reference device 20 includes attribute information on the machining that is the same as attribute information on machining of data set #k. The data set for machining performed by each of machining devices #1 to #k−1 includes attribute information on machining that is the same as the attribute information on the machining of data set #k. The reference number can be six to ten times the number of pieces of condition data included in a data set, for example.

In step S202A, processor 12 selects a data set having a difference from data set #k in the determination of step S202, the difference being smaller than a predetermined value. The selected data set is referred to as data set #t.

In step S202B, processor 12 causes reference device 20 to additionally perform machining. When causing reference device 20 to perform machining, processor 12 provides reference device 20 with condition data on the machining to be performed, and transmits control information for performing the machining using the provided condition data to reference device 20.

In step S202C, processor 12 acquires a data set for the machining additionally performed by reference device 20 and adds the data set to the integrated data set.

In step S203, processor 12 generates model #k from data set #k. Model #k is an estimation model that estimates result data included in data set #k using the condition data included in data set #k.

In step S204, processor 12 generates model #t from data set #t. Model #t is an estimation model that estimates result data included in data set #t using the condition data included in data set #t.

In step S205, processor 12 determines whether there is a significant difference between model #k generated in step S203 and model #t generated in step S204. For determining whether there is a significant difference between model #k and model #t, it is determined whether a difference between output values from model #k and model #t is larger than 10% of one of the output values when the same input value is input to model #k and model #t, for example. When the difference is larger than that, it is determined that there is a significant difference, and when the difference is not larger than that, it is determined that there is no significant difference. When it is determined that there is a significant difference between model #k and model #t (Yes in step S205), the processing proceeds to step S206, and otherwise (No in step S205), the processing proceeds to step S221.

In step S206, processor 12 generates condition data by changing the condition data in data set #k.

In step S207, processor 12 causes simulator 30 to perform a simulation using the condition data generated in step S206. When causing simulator 30 to perform the simulation, processor 12 provides the condition data generated in step S206 to simulator 30, and transmits control information for performing the simulation using the provided condition data to simulator 30.

In step S208, result data on the simulation performed by simulator 30 in step S207 is acquired. For example, processor 12 can acquire the result data by transmitting request information for acquiring the result data to simulator 30 and receiving the result data transmitted in response to the request information.

In step S209, processor 12 uses the result data on the simulation acquired in step S208 to determine whether a difference between the result data on the simulation and the result data in data set #t is smaller than a predetermined value. When it is determined that the difference is smaller than the predetermined value (Yes in step S209), the processing proceeds to step S210, and otherwise (No in step S209), the processing proceeds to step S206.

In step S210, processor 12 generates a correction data set by changing the condition data in data set #k to the condition data generated in step S206, and adds the generated correction data set serving as data set #k to the integrated data set.

In step S221, processor 12 adds data set #k to the integrated data set.

According to the series of processing illustrated in FIG. 4, processor 12 adds the data set or the correction data set for the machining performed by machining device #k to the integrated data set. Then, according to the series of processing illustrated in FIGS. 3 and 4, processor 12 can generate the integrated data set by integrating the data set of reference device 20 and the data set of machining devices 21 to 2N.

Hereinafter, the data set will be specifically described.

FIG. 5 is an explanatory diagram of an example of a data set for machining performed by reference device 20 according to the present exemplary embodiment. The data set shown in FIG. 5 is acquired by acquisition unit 11 from reference device 20 in step S101.

As shown in FIG. 5, the data set for the machining performed by reference device 20 includes data A, B, C, and D as condition data, and data E and F as result data.

FIG. 6 is an explanatory diagram of an example of a first data set for machining simulation according to the present exemplary embodiment. The data set shown in FIG. 6 is for the simulation performed in step S104.

The data set shown in FIG. 6 includes condition data A, B, C, and D that are provided from processing device 10, and that are respectively the same as condition data A, B, C, and D included in the data set (see FIG. 5) of reference device 20.

The data set shown in FIG. 6 includes result data E and F that are result data indicating results of the simulation performed by simulator 30 using condition data A, B, C, and D.

Result data E and F included in the data set shown in FIG. 6 are respectively the same as result data E and F included in the data set of reference device 20. This is because the operation parameters of simulator 30 are adjusted to cause simulator 30 to output result data on the machining performed by reference device 20 when condition data on the machining performed by reference device 20 is received.

FIG. 7 is an explanatory diagram of an example of a data set for machining performed by machining device #k according to the present exemplary embodiment. The data set shown in FIG. 7 is acquired by acquisition unit 11 from machining device #k in step S201.

As illustrated in FIG. 7, the data set for the machining performed by machining device #k includes data A and data B as condition data, and data E and data F as result data.

The data set shown in FIG. 7 does not include data C and D as condition data. This is because data C and D are not to be managed by machining device #k.

When a data value is set in data C in the data set for the machining performed by machining device #k, the set data value deviating from an assumed range of data C, the data set may be treated as a data set without including data C. The same applies to data D.

FIG. 8 is an explanatory diagram of an example of a second data set for machining simulation according to the present exemplary embodiment. FIG. 8 shows a data set that is included in the data set of the simulation performed by simulator 30 caused by acquisition unit 11 in step S207, and includes result data that matches result data on the machining performed by machining device #k.

The data set shown in FIG. 8 includes data A, B, C and D as condition data, and data E and F as result data.

Data A and B, which are condition data, are respectively the same as data A and B (see FIG. 7) in the data set for the machining performed by machining device #k.

Processor 12 sets “20” as a data value for each of data C and D that are condition data.

Data E and F, which are result data, are respectively the same as data E and F (see FIG. 7) in the data set for the machining performed by machining device #k. This means that result data E and F obtained as results of the simulation using the data set in which “20” is set as the data value of data C and D, which are the condition data, matches respectively with result data E and F included in the data set of machining device #k.

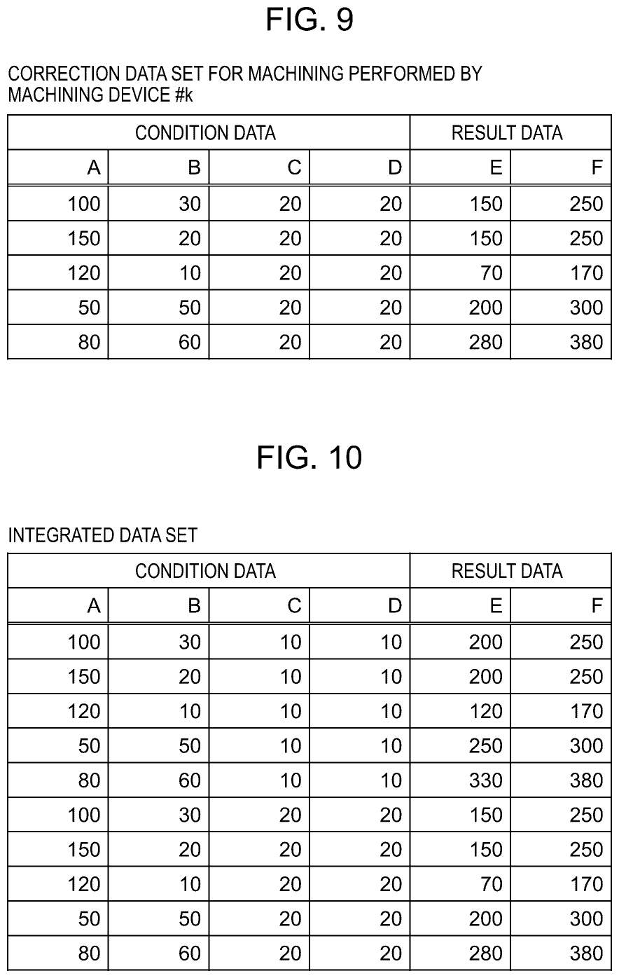

FIG. 9 is an explanatory diagram of an example of a correction data set for the machining performed by machining device #k according to the present exemplary embodiment. FIG. 9 shows a data set generated by changing the condition data based on the data set acquired from machining device #k in step S210.

The data set shown in FIG. 9 includes data A, B, C and D as condition data, and data E and F as result data.

Data A and B, which are condition data, are respectively the same as data A and B (see FIG. 7) in the data set for the machining performed by machining device #k.

Data C and data D, which are condition data, are respectively set as data C and data D in the condition data in the simulation, and specifically, “20” is set as a data value of each data. This means that result data E and F obtained as results of the simulation using the data set in which “20” is set as the data value of data C and D, which are the condition data, matches respectively with result data E and F included in the data set of machining device #k (see FIG. 8), and thus processor 12 set “20” as the data value of each of data C and D that are the condition data.

Data E and F, which are result data, are respectively the same as data E and F (see FIG. 7) in the data set for the machining performed by machining device #k.

FIG. 10 is an explanatory diagram of an example of an integrated data set according to the present exemplary embodiment. FIG. 10 shows the integrated data set to which the correction data set generated in step S210 is added.

The integrated data set shown in FIG. 10 includes the data set (see FIG. 5) for the machining performed by reference device 20 and the correction data set (see FIG. 9) for the machining performed by machining device #k. In this way, the correction data set for the machining performed by machining device #k is integrated with the data set for the machining performed by reference device 20. Then, when each of machining devices 21 to 2N is processed as machining device #k, the correction data set for the machining performed by machining devices 21 to 2N is integrated with the data set for the machining performed by reference device 20.

As described above, the information processing method of the present exemplary embodiment allows the data set for the machining performed by the second device and including a relatively small difference from the data set already added to the integrated data set to be added to the integrated data set. At this time, when the difference between the data set for the machining performed by the second device and the data set already added to the integrated data set is relatively large, the data set for the machining performed by the second device is corrected using a machining simulation simulating the machining performed by the first device to reduce the difference, and then is added to the integrated data set. Consequently, the data set for the machining performed by the first device and the data set for the machining performed by the second device can be appropriately integrated. As described above, the information processing method enables the data acquired from the plurality of devices to be appropriately integrated.

Additionally, it can be easily determined whether to correct the data set for the machining performed by the second device by using a difference between models for estimating the result data from the condition data for each of the data set already added for the second device and the data set for the machining performed by the second device. More specifically, when the difference is relatively large, it can be determined that the data set for the machining performed by the second device is to be corrected. Thus, the information processing method enables the data acquired from the plurality of devices to be appropriately integrated more easily.

Additionally, it can be easily determined whether to correct the data set for the machining performed by the second device by using a difference between models for estimating the result data from the condition data for each of the data set already added for the second device and the data set for the machining performed by the second device. More specifically, when the difference is relatively small, it is determined not to correct the data set for the machining performed by the second device, i.e., the data set for the machining performed by the second device is directly added to the data set for the machining performed by the first device. Thus, the information processing method enables the data acquired from the plurality of devices to be appropriately integrated more easily.

Then, the machining simulator simulating the machining performed by the first device is generated and used, so that a difference between the data set for the machining performed by the second device and the data set already added to the integrated data set can be evaluated with higher accuracy. As described above, the information processing method enables the data acquired from the plurality of devices to be appropriately integrated.

Additionally, the data value of the data defined as the data not to be controlled or measured is changed when the data set for the machining performed by the second device is corrected, so that the data set for the machining performed by the second device is added to the data set for the machining performed by the first device after the data value of the data not to be controlled or measured included in the data set for the machining performed by the second device is appropriately set. Thus, the information processing method enables the data acquired from the plurality of devices to be appropriately integrated even when the data set for the machining performed by the second device includes data not to be controlled or measured.

Then, the model for estimating the result data from the condition data can be appropriately generated using the integrated data set in which the data set for the machining performed by the first device and the data set for the machining performed by the second device are appropriately integrated. Thus, the information processing method enables the data acquired from the plurality of devices to be appropriately integrated, and an appropriate model to be generated using the integrated data set.

Each of components in the above exemplary embodiments may be composed of dedicated hardware, or implemented by executing a software program suitable for corresponding one of the components. Each of the components may be implemented by a program executor such as a CPU or a processor reading and executing a software program recorded in a recording medium such as a hard disk or semiconductor memory. Here, software for implementing the processing device and the like of the above exemplary embodiments is a program as described below.

That is, the program causes a computer to execute an information processing method including: acquiring one or more first data sets for each of one or more pieces of first machining performed by a first device, the one or more first data sets including condition data indicating a condition of the first machining and result data indicating a result of the one or more pieces of first machining; generating an integrated data set including the acquired one or more first data sets; acquiring a plurality of second data sets for second machining performed by each of a plurality of second devices, the plurality of second data sets including a second data set including condition data indicating a condition of the second machining and result data indicating a result of the second processing; adding a second data set for machining performed by the second device or a correction data set generated using the second data set to the integrated data set for each of the plurality of second devices; selecting one data set of the second data set or the correction data set, already added to the integrated data set, when the correction data set is generated, the one data set including a difference between the condition data included in the one data set and the condition data included in the second data set, the difference being smaller than a predetermined value; and correcting the condition data included in the second data set to correction data to generate the correction data set, the correction data satisfying a condition that a difference between result data indicating a result of a machining simulation performed under the condition of the correction data and result data included in the one data set is smaller than a predetermined value.

Although the processing device and the like according to one or more aspects have been described above based on the exemplary embodiments, the present disclosure is not limited to exemplary embodiments. Configurations in which various modifications conceivable by those skilled in the art are applied to the present exemplary embodiment and configurations constructed by combining components in different exemplary embodiments may also be included in the scope of one or more aspects without departing from the gist of the present disclosure.

### INDUSTRIAL APPLICABILITY

The present disclosure is applicable to an information processing device that integrates data acquired from a plurality of devices.

### REFERENCE MARKS IN THE DRAWINGS

1: system
10: processing device
11: acquisition unit
12: processor
13: storage unit
20: reference device
21, 22, . . . , 2N: machining device
30: simulator
91: laser beam
92: scanning speed 92
93: surface welding width
94: gap width
95: interface welding width
9A, 9B: plate
N: network

1. An information processing method comprising:
acquiring one or more first data sets for one or more pieces of first machining performed by a first device, each of the one or more first data sets including condition data indicating a condition of a corresponding one of the one or more pieces of first machining and result data indicating a result of the corresponding one of the one or more pieces of first machining;
generating an integrated data set including the acquired one or more first data sets;
acquiring a plurality of second data sets for a plurality of pieces of second machining performed by a plurality of second devices, each of the plurality of second data sets including condition data indicating a condition of a corresponding one of the plurality of pieces of second machining and result data indicating a result of the corresponding one of the plurality of pieces of second machining; and
adding, for each of the plurality of second devices, (i) a corresponding one of the plurality of second data sets or (ii) a correction data set generated using the corresponding one of the plurality of second data sets to the integrated data set,
generating the correction data set including;
selecting one data set which is already added to the integrated data set,
the one data set being a second data set or a correction data set, a difference existing between the condition data included in the one data set and the condition data included in the corresponding one of the plurality of second data sets, the difference being smaller than a predetermined value; and
correcting the condition data included in the corresponding one of the plurality of second data sets to correction data to generate the correction data set, and
the correction data satisfying a condition that a difference between result data indicating a result of a machining simulation performed under the condition of the correction data and result data included in the one data set is smaller than a predetermined value.

2. The information processing method according to claim 1, wherein
the adding of the corresponding one of the plurality of second data sets or the correction data set includes:
determining whether a difference between a first model and a second model is larger than a predetermined value, the first model being for estimating the result data included in the one data set using the condition data included in the one data set and the second model being for estimating the result data included in the corresponding one of the plurality of second data sets using the condition data included in the corresponding one of the plurality of second data sets; and
generating the correction data set and adding the correction data set to the integrated data set when the difference is larger than the predetermined value.

3. The information processing method according to claim 1, wherein
the adding of the corresponding one of the plurality of second data sets or the correction data set includes:
determining whether a difference between a first model and a second model is larger than a predetermined value, the first model being for estimating the result data included in the one data set using the condition data included in the one data set and the second model being for estimating the result data included in the corresponding one of the plurality of second data sets using the condition data included in the corresponding one of the plurality of second data sets; and
adding the corresponding one of the plurality of second data sets to the integrated data set when the difference is not larger than the predetermined value.

4. The information processing method according to claim 1, further comprising:
creating a machining simulator simulating the first machining using condition data indicating a condition of the first machining and result data indicating a result of the first machining; and
performing the machining simulation using the created machining simulator.

5. The information processing method according to claim 1, wherein the correcting of the condition data included in the corresponding one of the plurality of second data sets includes changing a data value of data defined as data not to be controlled or measured among the condition data included in the corresponding one of the plurality of second data sets.

6. The information processing method according to claim 1, further comprising
generating a third model for estimating the result data included in the integrated data set using the condition data included in the integrated data set after the adding of the corresponding one of the plurality of second data sets or the correction data set for each of the plurality of second devices.

7. An information processing device comprising:
an acquisition unit; and
a processor connected to the acquisition unit,
wherein the acquisition unit acquires one or more first data sets for one or more pieces of first machining performed by a first device, each of the one or more first data sets including condition data indicating a condition of a corresponding one of the one or more pieces of first machining and result data indicating a result of the corresponding one of the one or more pieces of first machining,
the processor generates an integrated data set including the one or more first data sets acquired by the acquisition unit,
the acquisition unit acquires a plurality of second data sets for a plurality of pieces of second machining performed by a plurality of second devices, each of the plurality of second data sets including condition data indicating a condition of a corresponding one of the plurality of pieces of second machining and result data indicating a result of the corresponding one of the plurality of pieces of second machining,
the processor adds, for each of the plurality of second devices, (i) a corresponding one of the plurality of second data sets or (ii) a correction data set generated using the corresponding one of the plurality of second data sets to the integrated data set,
the processor generates the correction data set by:
selecting one data set which is already added to the integrated data set, the one data set being a second data set or a correction data set, a difference existing between the condition data included in the one data set and the condition data included in the corresponding one of the plurality of second data sets, the difference being smaller than a predetermined value; and
correcting the condition data included in the corresponding one of the plurality of second data sets to correction data to generate the correction data set, and
the correction data satisfies a condition that a difference between result data indicating a result of a machining simulation performed under the condition of the correction data and result data included in the one data set is smaller than a predetermined value.
